(19) United States
(12) Patent Application Publication
(10) Pub. No.: US 2024/0177199 A1
(43) Pub. Date: May 30, 2024

(54) Generation and Recommendation Method of Smart Home Scene

(71) Applicant: SHENZHEN CHENBEI TECHNOLOGY CO., LTD., SHENZHEN (CN)

(72) Inventors: Lei Luo, SHENZHEN (CN); Hongyao Luo, SHENZHEN (CN)

(73) Assignee: SHENZHEN CHENBEI TECHNOLOGY CO., LTD., SHENZHEN, GD (CN)

(21) Appl. No.: 18/518,195

(22) Filed: Nov. 22, 2023

(30) Foreign Application Priority Data
Nov. 28, 2022 (CN) CN202211498915.0

(51) Int. Cl. G06Q 30/0251

(52) U.S. Cl. CPC G06Q 30/0271

(57) ABSTRACT

The present application provides a method, an apparatus, a device, and a medium for generating and recommending smart home scenarios. The method comprises the following steps: selecting trigger conditions and execution actions that meet predefined selection criteria from user-activated scenarios of the user group within a predefined time period; wherein, the scenarios comprise at least one trigger condition and at least one execution action; combining the selected trigger conditions and execution actions to generate at least one target scenario; calculating and obtaining the value of the activation probability for each target scenario of the target user; and generating a scenario recommendation list by ranking the target scenarios based on the values of their activation probabilities. The present application is capable of automating scenario construction and providing personalized recommendations for users.

### CROSS-REFERENCE TO RELATED APPLICATIONS

This application claims priority to and benefit of the earlier Chinese Patent Application No. CN202211498915.0 filed on Nov. 28, 2022, the content of which is incorporated herein by reference in its entirety.

### TECHNICAL FIELD

The present application relates to the field of smart home technology, and in particular, to a method, an apparatus, a device, and a medium for generating and recommending smart home scenarios.

### BACKGROUND OF THE INVENTION

The difference between smart homes and ordinary homes lies in their scenario design and scenario services. Smart home scenarios and routines help to automate and customize home devices based on a user's needs, preferences, and schedules. Through the Internet of Things (IOT) technology, smart homes are capable of offering users a variety of smart home scenarios, realizing an interactive process between users and devices.

Scenario services are applied in the automated settings of smart homes. Currently, smart home scenarios are mostly official template scenarios, which are generated by predefined conditions and execution actions. These template scenarios are helpful for “one-click” automated setup, eliminating the need for users to configure settings themselves. However, predefined scenarios rely on manual configuration, and their applicability is limited by developers' understanding of scenarios and user needs. Moreover, the recommendation of predefined scenarios is not personalized to individual users, making it challenging for users to quickly find scenarios that meet their specific needs.

### SUMMARY OF THE INVENTION

In view of this, the embodiments of the present application provide a method, an apparatus, a device, and a medium for generating and recommending smart home scenarios, with the aim of realizing automated scenario construction and providing personalized recommendations for users.

In a first aspect, an embodiment of the present application provides a method for generating and recommending smart home scenarios, which comprises the following steps:
selecting trigger conditions and execution actions that meet predefined selection criteria from the user-activated scenarios of the user group within a predefined time period; wherein, the scenarios comprise at least one trigger condition and at least one execution action; combining the selected trigger conditions and execution actions to generate at least one target scenario; calculating and obtaining the value of the activation probability for each target scenario of the target user; and generating a scenario recommendation list by ranking the target scenarios based on the values of their activation probabilities.

In a possible embodiment, the selection of trigger conditions and execution actions that meet predefined selection criteria from user-activated scenarios of the user group within a predefined time period, comprises separately counting the activation frequency of each trigger condition and each execution action based on the trigger conditions and execution actions in the user-activated scenarios; sorting the trigger conditions in the user-activated scenarios in descending order of activation frequency and selecting a plurality of trigger conditions; and sorting the execution actions in the historically-activated scenarios in descending order of activation frequency and selecting a plurality of execution actions.

In a possible embodiment, the method further comprises periodically acquiring user-activated scenarios of the user group to ensure the acquisition of updated user-activated scenarios; and the selection of trigger conditions and execution actions that meet predefined selection criteria from user-activated scenarios of the user group within a predefined time period, which comprises selecting trigger conditions and execution actions that meet predefined selection criteria from the updated user-activated scenarios.

In a possible embodiment, selected trigger conditions and the execution actions are combined to generate a plurality of target scenarios as follows: combining each of the selected trigger conditions with the selected execution actions, respectively, thereby obtaining a combination of at least one trigger condition and the execution actions; and generating at least one target scenario based on the combination of at least one trigger condition and the execution actions.

In a possible embodiment, calculations are performed to obtain the value of the activation probability for each target scenario of the target user by calculating the activation count of each of the target scenarios, as well as the rates of compliance with the target user's needs, device relevance, behavioral relevance, attribute relevance, and scenario duplication for each scenario; and calculating the value of the activation probability for each target scenario of the target user based on the activation count, the rates of compliance with the user's needs, device relevance, behavioral relevance, attribute relevance, and scenario duplication, and weighing the respective parameters.

In a possible embodiment, the generation of a scenario recommendation list by ranking the target scenarios based on the values of their activation probabilities, comprises obtaining the sorted result of a plurality of activation probability values by sorting the values representing the activation probabilities for the respective target scenarios in descending order; determining the ranking of the target scenarios based on the sorted result of a plurality of activation probability values; and generating a scenario recommendation list based on the ranking of the target scenarios.

In a possible embodiment, the method further comprises selecting the predefined number of scenarios from the top-ranking scenarios in the scenario recommendation list as the recommended scenarios for recommendation to the user; removing recommended scenarios that have been recommended but have not been activated and have reached a predefined threshold count for non-activation, and updating the arrangement order of scenarios within the scenario recommendation list.

In a second aspect, an embodiment of the present application provides an apparatus for generating and recommending smart home scenarios, which comprises a selection module for selecting trigger conditions and execution actions that meet predefined selection criteria from the user-activated scenarios of the user group within a predefined time period; wherein, the scenarios comprise at least one trigger condition and at least one execution action; a combination module for combining the selected trigger conditions and execution actions to generate at least one target scenario; a computing module for calculating and obtaining the value of the activation probability for each target scenario of the target user; and a generation module for generating a scenario recommendation list by ranking the target scenarios based on the values of their activation probabilities.

In a third aspect, an embodiment of the present application provides a computing device comprising a memory, a processor, and a computer program stored in the memory and executable on the processor, wherein the processor, when executing the computer program, realizes any of the steps of the method for generating and recommending smart home scenarios described in the first aspect of the present application.

In a fourth aspect, an embodiment of the present application provides a computer-readable storage medium comprising a computer program stored thereon, wherein the computer program, when executed by a processor, performs any of the steps of the method for generating and recommending smart home scenarios described in the first aspect of the present application.

The technical solutions provided in the present application have the following beneficial effects. The method for generating and recommending smart home scenarios provided in the present application, comprises the following: selecting trigger conditions and execution actions that meet predefined selection criteria from the user-activated scenarios of the user group within a predefined time period; wherein the scenarios comprise at least one trigger condition and at least one execution action, so as to obtain a broader set of trigger conditions and execution actions activated by users; combining the selected trigger conditions and execution actions to generate at least one target scenario, realizing the automated construction of a plurality of target scenarios, so as to offer a plurality of scenario possibilities and create a more extensive scenario library; and obtaining the value of the activation probability for each target scenario of the target user through calculation and generating a scenario recommendation list by ranking the target scenarios based on the values of their activation probabilities, so as to provide personalized recommendations for the target user based on the order of recommendations from the scenario recommendation list, enabling users to quickly find scenarios that meet their needs, ultimately enhancing user experience.

In order to make the objectives, features, and advantages of the present application clearer and more understandable, the following detailed explanation is provided in conjunction with the preferred embodiments and attached drawings.

### BRIEF DESCRIPTION OF DRAWINGS

To provide a clearer explanation of the technical solutions in the embodiments of the present application, a brief introduction of the attached drawings required for the embodiments is presented below. It should be understood that the following drawings only illustrate certain embodiments of the present application and should not be considered as limiting the scope. Those having ordinary skill in the art can obtain other related drawings based on these drawings without exercising creative effort.

FIG. 1 is a flow diagram illustrating a method for generating and recommending smart home scenarios provided in an embodiment of the present application;

FIG. 2 is a flow diagram illustrating a method for selecting trigger conditions and execution actions in scenarios provided in an embodiment of the present application;

FIG. 3 is a flow diagram illustrating a method for generating target scenarios provided in an embodiment of the present application;

FIG. 4 is a flow diagram illustrating a method for generating a scenario recommendation list provided in an embodiment of the present application;

FIG. 5 is a schematic diagram of recommended scenarios exposed on a smart home platform provided in an embodiment of the present application;

FIG. 6 is a schematic diagram illustrating the structure of an apparatus for generating and recommending smart home scenarios provided in an embodiment of the present application;

FIG. 7 is a schematic diagram illustrating the structure of a computing device provided in an embodiment of the present application.

### DETAILED DESCRIPTION OF THE INVENTION

Clear and complete descriptions of the technical solutions in the embodiments of the present application are presented below, in conjunction with the attached drawings on the embodiments of the present application, so as to provide a clearer understanding of the objectives, technical solutions, and advantages of the embodiments of the present application. It is evident that the described embodiments are only a part of the embodiments of the present application and not the entirety. Typically, the components of the embodiments of the present application, which are described and shown in these attached drawings, may be arranged and designed in various different configurations. Therefore, the detailed descriptions of the embodiments of the present application provided in the attached drawings are not intended to limit the scope of protection of the present application but merely represent selected embodiments of the present application. Based on the embodiments of the present application, all other embodiments acquired by those skilled in the art without exercising creative effort are within the scope of protection of the present application.

In the following description, references to “some embodiments” cover subsets of all possible embodiments. It should be understood that “some embodiments” may refer to the same subset or different subsets of all possible embodiments, and they may be combined with each other without conflict.

In prior art, when using smart home scenarios, there may be the following issues:

Currently, smart home scenarios are mostly official template scenarios, which are created by predefined conditions and execution actions. These template scenarios are helpful in realizing one-click automated setup, eliminating the need for users to configure settings themselves. However, predefined scenarios rely on manual configuration, and their applicability is limited by developers' understanding of scenarios and user needs. Many of the designed scenarios may not meet user needs, and the recommendation of predefined scenarios is not personalized, resulting in a less satisfying user experience.

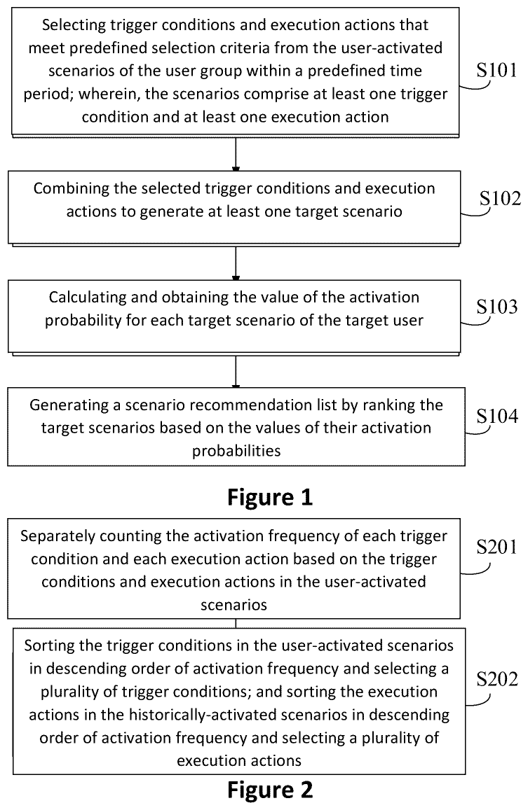

Based on the aforementioned drawbacks, an embodiment of the present application provides a method for generating and recommending smart home scenarios, as illustrated in FIG. 1, which comprises the following steps:

S101, selecting trigger conditions and execution actions that meet predefined selection criteria from the user-activated scenarios of the user group within a predefined time period; wherein, the scenarios comprise at least one trigger condition and at least one execution action;

S102, combining the selected trigger conditions and execution actions to generate at least one target scenario;

S103, calculating and obtaining the value of the activation probability for each target scenario of the target user;

and S104, generating a scenario recommendation list by ranking the target scenarios based on the values of their activation probabilities.

The following are explanations for the exemplary steps in the described embodiments of the present application.

In step S101, trigger conditions and execution actions that meet predefined selection criteria are selected from the user-activated scenarios of the user group within a predefined time period; wherein, the scenarios comprise at least one trigger condition and at least one execution action.

In some embodiments, the predefined time period may be the past three months from the current time, and the predefined selection criteria may comprise a trigger condition activated and executed over 500 times within the past three months in the user-activated scenario; each scenario is composed of trigger conditions and execution actions, and may comprise one or more trigger conditions and one or more execution actions.

In step S102, the selected trigger conditions and execution actions are combined to generate at least one target scenario.

In some embodiments, trigger conditions may only be combined with execution actions, while in another embodiment, trigger conditions and execution actions may be combined separately, i.e., trigger conditions and execution actions in a scenario may be either single elements or combinations of a plurality of elements. To reduce the complexity of trigger conditions and execution actions, limits may be placed on the number of elements for trigger conditions and execution actions. For example, there may be a limit of fewer than three elements for trigger conditions and fewer than three elements for execution actions. The specific number of elements may be adjusted based on the actual situation. The generated target scenario consists of trigger conditions followed by execution actions.

In step S103, the value of the activation probability for each target scenario of the target user is obtained through calculation, which specifically comprises the following steps: calculating the activation count of each of the target scenarios, as well as the rates of compliance with the target user's needs, device relevance, behavioral relevance, attribute relevance, and scenario duplication for each scenario.

The activation count of a target scenario is the number of activations of the same scenario in the user group.

Needs compliance is calculated based on the activation ratio and the activation count of the same scenario.

Device relevance refers to the correlation between the trigger conditions and execution actions in the target scenario and the user's devices, with factors for calculation including, but not limited to, device types, device quantities, device usage times, usage frequencies, etc., wherein the user has either bound or uploaded device information to the smart home platform.

Behavioral relevance refers to the correlation between the user's behavior and the behavior of users who have already activated the same scenario, with factors for calculation including, but not limited to, browsing, clicking, long-pressing, time spent, clicking moment, and exit actions, etc., of/on relevant pages; the calculation involves tallying the user's relevant behaviors that match those of users who have already activated the scenario and users with more matching behaviors have a higher weighting.

Attribute relevance refers to the correlation between the user's attributes and the attributes of users who have already activated the same scenario, with factors for calculation including, but not limited to, age, gender, geographic location, etc. The calculation involves tallying the user's relevant attributes that match those of users who have already activated the scenario and users with more matching attributes have a higher weighting.

Scenario duplication refers to the degree of overlap between the trigger conditions and execution actions in the scenarios that have already been activated and the automatically generated scenarios; if the activated scenarios and the automatically generated scenarios are completely identical, duplication is 100%, while if they are completely different, duplication is 0%.

Wherein, the rate of compliance between the scenario and the user's need is calculated based on the activation ratio and the activation count of the scenario. Specifically, it is calculated as follows: Activation ratio=activation frequency of this scenario/number of recommendations for this scenario, needs compliance rate=first weighting*recommended activation ratio+second weighting*activation count

Considering that in practical situations, scenarios with high activation counts may have lower activation ratios due to higher exposure, the actual values of the first weighting and the second weighting may be adjusted differently based on the range in which the activation count falls, for a more reasonable calculation of the rate of compliance with user needs. For instance, if it's considered that scenarios with activation counts greater than 500 undoubtedly meet user needs, then when the activation count is >500, the rate of compliance with user needs would be calculated as 30%*activation ratio+70%*activation count; and when the activation count is ≤500, the rate of compliance with user needs would be calculated as 50%*activation ratio+50%*activation count. The setting of weighting values may vary based on segmented divisions of the activation count to achieve different proportions. For scenarios where the activation ratio is below the predefined value and the absolute activation count is also below the predefined value (e.g., activation ratio≤0.01% and activation count≤3), the scenarios are considered as non-compliant with user needs and are removed from the automatically generated scenario list. The predefined values of the activation ratio and activation count may be set and adjusted according to the actual situation.

According to the activation count as well as the rates of compliance with user needs, device relevance, behavioral relevance, attribute relevance, and scenario duplication, and their respective weightings, the value of the activation probability for each target scenario of the target user are calculated separately. The specific calculation process is as follows:

Activation probability=weighting 1*activation count of target scenario+weighting 2*needs compliance+weighting 3*device relevance+weighting 4*behavioral relevance+weighting 5*attribute relevance−weighting 6*scenario duplication. The weightings are adjusted based on the calculated recommendation effectiveness to ensure that the algorithm computes high-probability scenarios that are highly likely to be activated by the user.

In step S104, a scenario recommendation list is generated by ranking the target scenarios based on the values of their activation probabilities.

In some embodiments, when there are scenarios with the same activation probability, the solution is as follows: If the activation probability is the same, the scenario with a higher activation count is prioritized for recommendation; if the activation count is also the same, the scenario with a higher activation ratio is prioritized for recommendation; if the activation ratio is the same, the scenario with a higher device relevance is prioritized for recommendation; if the device relevance is also the same, the scenario with a higher behavioral relevance is prioritized for recommendation; if the behavioral relevance is the same, the scenario with a higher attribute relevance is prioritized for recommendation; and if the attribute relevance is the same, then the order among scenarios with equal values for all the above parameters is randomly arranged.

In some embodiments, for scenarios with an activation count of 0, i.e., completely new scenarios with an activation ratio of 0, if the calculated activation probability is the same as the activation probability of other scenarios with an activation count not equal to 0, then this scenario with an activation count of 0 is prioritized for recommendation.

The above method for generating and recommending smart home scenarios comprises the following: selecting trigger conditions and execution actions that meet predefined selection criteria from the user-activated scenarios of the user group within a predefined time period; wherein the scenarios comprise at least one trigger condition and at least one execution action, so as to obtain a broader set of trigger conditions and execution actions activated by users; combining the selected trigger conditions and execution actions to generate at least one target scenario, realizing the automated construction of a plurality of target scenarios, so as to offer a plurality of scenario possibilities and create a more extensive scenario library; and obtaining the value of the activation probability for each target scenario of the target user through calculation and generating a scenario recommendation list by ranking the target scenarios based on the values of their activation probabilities, so as to provide personalized recommendations for the target user based on the order of recommendations from the scenario recommendation list, enabling users to quickly find scenarios that meet their needs, ultimately enhancing user experience.

In some embodiments, as shown in FIG. 2, step S101 includes the following steps:

S201, separately counting the activation frequency of each trigger condition and each execution action based on the trigger conditions and execution actions in the user-activated scenarios;

In some embodiments, each scenario has at least one trigger condition, i.e., trigger conditions for a scenario may be a single condition or a plurality of conditions. The logical relationships among a plurality of conditions may be further divided into “and” and “or” types. For example, a single condition could be “when the time reaches 9 a.m.”; an “and”-type plurality of conditions could be “when the time reaches 9 a.m.” and “the air purifier status is ‘on,’” while an “or”-type plurality of conditions could be “when it's sunset” or “when the light intensity is below 500.” The execution actions for scenarios may also be a single action or a plurality of actions, and for scenarios with a plurality of actions, they are executed in sequence.

When counting the activation frequency of trigger conditions and execution actions, for scenarios with a plurality of conditions, the activation count is considered as 1 when it's a set of trigger conditions within that scenario. The activation count for execution actions, whether they are single actions or individual actions within a plurality of actions, is counted as 1 for each execution action. For example, if the scenario is defined as “when the time reaches 9 a.m. and the air purifier status is ‘on,’ turn off the purifier and open the curtains,” the trigger conditions for this scenario are “when the time reaches 9 a.m.” and “the air purifier status is ‘on,’” and the activation count for trigger conditions is 1; the execution actions of this scenario are “turn off the purifier” as execution action 1 and “open the curtains” as execution action 2, and the activation count for execution actions is 2.

S202, sorting the trigger conditions in the user-activated scenarios in descending order of activation frequency and selecting a plurality of trigger conditions; and sorting the execution actions in the historically-activated scenarios in descending order of activation frequency and selecting a plurality of execution actions.

In some embodiments, the sorting of scenarios is based on their activation frequency, from highest to lowest. However, in consideration of the statistical long-tail effect, as well as reduction of the combinations of trigger conditions and execution actions, there is a need to limit the number of trigger conditions and execution actions. When selecting trigger conditions and execution actions, limitations may be imposed on the activation count or the number of trigger conditions and execution actions. For example, if trigger conditions with activation counts greater than 500 are limited to the top 100, based on filtering by activation count, then only the top 100 trigger conditions will be selected. Similarly, if a limit of 30 trigger conditions is set based on the number of trigger conditions, then only the top 30 trigger conditions will be selected. The selection of execution actions follows the same process as trigger conditions.

In some embodiments, the automatically generated scenarios may comprise some scenarios that users do not need or rarely need, or there may be significant changes in the content and quantity of the selected trigger conditions or execution actions. Therefore, it is necessary to periodically recalculate and update the automatically generated scenario list by combining it with user activation of recommended scenarios to ensure that the automatically generated scenarios can keep up with trends and have a higher level of compliance with user needs. Therefore, the method for generating and recommending smart home scenarios described in the embodiments of the present application further comprises periodically acquiring user-activated scenarios of the user group to ensure the acquisition of updated user-activated scenarios; and the selection of trigger conditions and execution actions that meet predefined selection criteria from user-activated scenarios of the user group within a predefined time period, which comprises selecting trigger conditions and execution actions that meet predefined selection criteria from the updated user-activated scenarios.

In some embodiments, periodic acquisition of user-activated scenarios from the user group is performed, and this periodic acquisition may be initiated through either of two triggering methods: time-based triggering: e.g., triggering once every week; and condition-based triggering: e.g., when the activation frequency of a particular trigger condition exceeds 100 for the first time. The specific time and conditions may be adjusted based on actual operation.

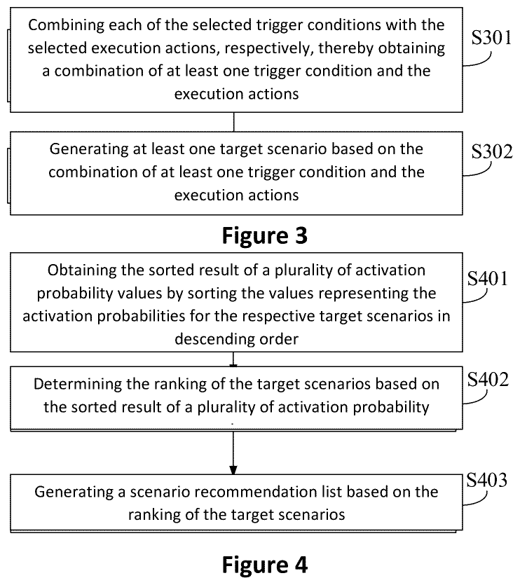

In some embodiments, as shown in FIG. 3, step S102 comprises the following steps:

S301, combining each of the selected trigger conditions with the selected execution actions, respectively, thereby obtaining a combination of at least one trigger condition and the execution actions.

In some embodiments, each trigger condition is combined with all execution actions. For example, if there are a total of 10 trigger conditions and 10 execution actions, then each trigger condition is combined with all 10 execution actions, resulting in a total of 100 combinations.

S302, generating at least one target scenario based on the combination of at least one trigger condition and the execution action.

Based on the obtained combinations, each combination corresponds to a target scenario.

In some embodiments, as shown in FIG. 4, step S104 comprises the following steps:

S401, obtaining the sorted result of a plurality of activation probability values by sorting the values representing the activation probabilities for the respective target scenarios in descending order.

S402, determining the ranking of the target scenarios based on the sorted result of a plurality of activation probability values; and S403, generating a scenario recommendation list based on the ranking of the target scenarios.

The scenario recommendation list generated using the above method will prioritize scenarios with higher user activation probabilities towards the top of the recommendation list, so that users are able to quickly find scenarios that meet their needs, thereby enhancing user experience.

In some embodiments, the method for generating and recommending smart home scenarios further comprises selecting the predefined number of scenarios from the top-ranking scenarios in the scenario recommendation list as the recommended scenarios for exposure.

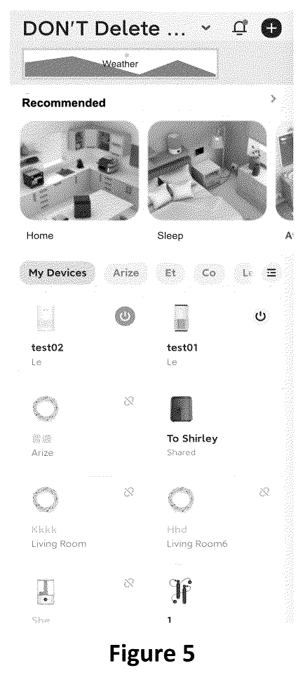

In some embodiments, there may be a plurality of scenarios in the scenario recommendation list, but the smart home platform can only display a few scenarios. For example, as shown in FIG. 5, only three recommended scenarios are exposed (this number could also be set to four or five; users can browse them by swiping left or right) and users can click on the “expand” button to view the full scenario recommendation list.

In some embodiment, recommended scenarios that have been recommended but have not been activated and have reached a predefined threshold count for non-activation are removed, and the arrangement order of scenarios within the scenario recommendation list is updated. For example, the predefined threshold could be set as three times. If a recommendation scenario has been recommend more than three times without user activation, it is removed from the recommendations; subsequently, the next highest scenario that has not been activated is then recommended, and this process continues for other scenarios in descending order of priority.

In some embodiments, if the devices involved in the exposed recommendation scenarios are devices that the user does not currently possess, recommendations for purchasing the relevant products are added.

In summary, the embodiments of the present application offer the following beneficial effects:

The method for generating and recommending smart home scenarios provided in the embodiments of the present application comprises the following: selecting trigger conditions and execution actions that meet predefined selection criteria from the user-activated scenarios of the user group within a predefined time period; wherein the scenarios comprise at least one trigger condition and at least one execution action, so as to obtain a broader set of trigger conditions and execution actions activated by users; combining the selected trigger conditions and execution actions to generate at least one target scenario, realizing the automated construction of a plurality of target scenarios, so as to offer a plurality of scenario possibilities and create a more extensive scenario library; and obtaining the value of the activation probability for each target scenario of the target user through calculation and generating a scenario recommendation list by ranking the target scenarios based on the values of their activation probabilities, so as to provide personalized recommendations for the target user based on the order of recommendations from the scenario recommendation list, enabling users to quickly find scenarios that meet their needs, ultimately enhancing user experience.

Based on the same inventive concept, among the embodiments of the present application, an apparatus for generating and recommending smart home scenarios that corresponds to the method for generating and recommending smart home scenarios in the first embodiment is also provided. As the principles for problem resolution in this device are similar to the method described above, the implementation of the device can be understood by referencing the method, and repetitive details will not be reiterated.

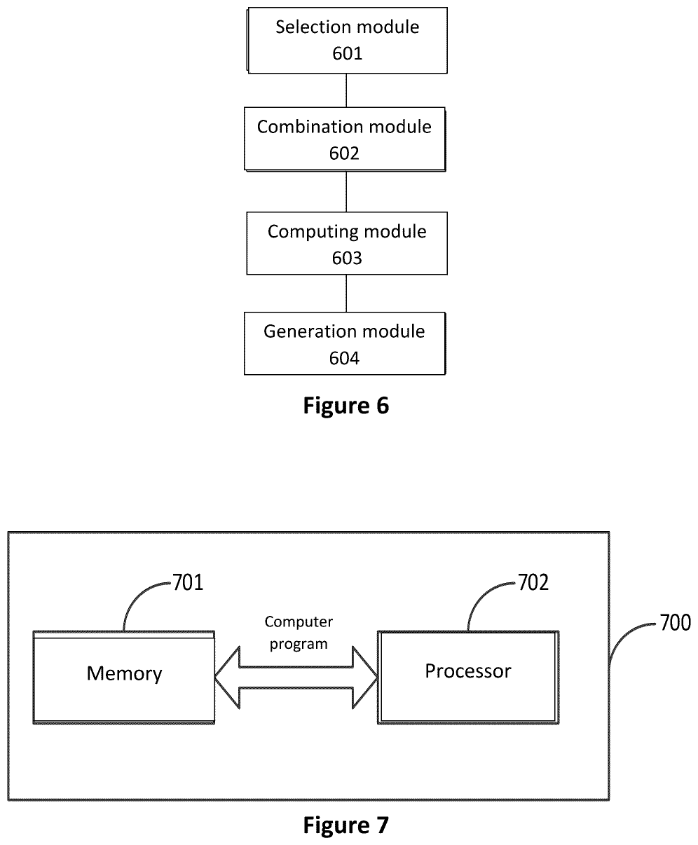

FIG. 6 is a schematic diagram illustrating the structure of the apparatus for generating and recommending smart home scenarios provided in the present application. As shown in FIG. 6, the apparatus for generating and recommending smart home scenarios comprises a selection module 601 for selecting trigger conditions and execution actions that meet predefined selection criteria from the user-activated scenarios of the user group within a predefined time period; wherein, the scenarios comprise at least one trigger condition and at least one execution action; a combination module 602 for combining the selected trigger conditions and execution actions to generate at least one target scenario; a computing module 603 for calculating and obtaining the value of the activation probability for each target scenario of the target user; and a generation module 604 for generating a scenario recommendation list by ranking the target scenarios based on the values of their activation probabilities.

Those skilled in the art should understand that the functional realization of the various modules in the apparatus for generating and recommending smart home scenarios shown in FIG. 6 can be understood by referring to the relevant descriptions of the method for generating and recommending smart home scenarios described above. The functionalities of the various units in the apparatus for generating and recommending smart home scenarios shown in FIG. 6 may be realized through the execution of a program on a processor or through specific logic circuits.

In a possible embodiment, the selection module 601 separately counts the activation frequency of each trigger condition and each execution action based on the trigger conditions and execution actions in the user-activated scenarios; sorts the trigger conditions in the user-activated scenarios in descending order of activation frequency and selecting a plurality of trigger conditions; and sorts the execution actions in the historically-activated scenarios in descending order of activation frequency and selecting a plurality of execution actions.

In a possible embodiment, the apparatus for generating and recommending smart home scenarios is further used for periodically acquiring user-activated scenarios of the user group to ensure the acquisition of updated user-activated scenarios. The selection of trigger conditions and execution actions that meet predefined selection criteria from user-activated scenarios of the user group within a predefined time period, which comprises selecting trigger conditions and execution actions that meet predefined selection criteria from the updated user-activated scenarios.

In a possible embodiment, the combination module 602 combines each of the selected trigger conditions with the selected execution actions, respectively, thereby obtaining a combination of at least one trigger condition and the execution actions; generates at least one target scenario based on the combination of at least one trigger condition and the execution actions.

In a possible embodiment, the computing module 603 calculates the activation count of each target scenario, as well as the rates of compliance with the target user's needs, device relevance, behavioral relevance, attribute relevance, and scenario duplication for each scenario; and calculates and obtains the value of the activation probability for each target scenario of the target user based on the activation count, rates of compliance with the user's needs, device relevance, behavioral relevance, attribute relevance, and scenario duplication, and the weightings of the respective parameters.

In a possible embodiment, the generation module 604 obtains the sorted result of a plurality of activation probability values by sorting the values representing the activation probabilities for the respective target scenarios in descending order; determines the ranking of the target scenarios based on the sorted result of a plurality of activation probability values; and generates a scenario recommendation list based on the ranking of the target scenarios.

In a possible embodiment, the apparatus for generating and recommending smart home scenarios is further used for selecting the predefined number of scenarios from the top-ranking scenarios in the scenario recommendation list as the recommended scenarios for exposure; removing recommended scenarios that have been exposed but have not been activated and have reached a predefined threshold count for non-activation, and updating the arrangement order of scenarios within the scenario recommendation list.

The above apparatus for generating and recommending smart home scenarios is utilized for the following: to select trigger conditions and execution actions that meet predefined selection criteria from the user-activated scenarios of the user group within a predefined time period using the selection module; wherein the scenarios comprise at least one trigger condition and at least one execution action, so as to obtain a broader set of trigger conditions and execution actions activated by users; to combine the selected trigger conditions and execution actions to generate at least one target scenario using the combination module, realizing the automated construction of a plurality of target scenarios, so as to offer a plurality of scenario possibilities and create a more extensive scenario library; to obtain the value of the activation probability for each target scenario of the target user through calculation using the computing module, and to generate a scenario recommendation list by ranking the target scenarios based on the values of their activation probabilities using the generation module, so as to provide personalized recommendations for the target user based on the order of recommendations from the scenario recommendation list, enabling users to quickly find scenarios that meet their needs, ultimately enhancing user experience.

A computing device 700 corresponding to the method for generating and recommending smart home scenarios outlined in FIG. 1, is also provided among the embodiments of the present application. As shown in FIG. 7, the device comprises a memory 701, a processor 702, and a computer program stored in the memory 701 and executable on the processor 702, wherein the processor 702, when executing the computer program, realizes the method for generating and recommending smart home scenarios described above.

Specifically, the memory 701 and the processor 702 described above may be a general-purpose memory and a general-purpose processor without specific limitations. When the processor 702 runs the computer program stored in the memory 701, it is capable of executing the method for generating and recommending smart home scenarios as described above, thereby solving the problem in prior art where personalized recommendations of smart home scenarios cannot be realized for users.

A computer-readable storage medium corresponding to the method for generating and recommending smart home scenarios outlined in FIG. 1, is also provided among the embodiments of the present application. The computer-readable storage medium comprises a computer program stored thereon, wherein the computer program, when executed by a processor, performs the steps of the method for generating and recommending smart home scenarios as described above.

Specifically, the storage medium may be a general-purpose storage medium such as a mobile disk, hard drive, etc. When the computer program stored on this storage medium is run, it can execute the method for generating and recommending smart home scenarios as described above, thereby solving the problem in prior art where personalized recommendations of smart home scenarios cannot be realized for users.

The above computer-readable storage medium is utilized for the following: to select trigger conditions and execution actions that meet predefined selection criteria from the user-activated scenarios of the user group within a predefined time period; wherein the scenarios comprise at least one trigger condition and at least one execution action, so as to obtain a broader set of trigger conditions and execution actions activated by users; to combine the selected trigger conditions and execution actions to generate at least one target scenario, realizing the automated construction of a plurality of target scenarios, so as to offer a plurality of scenario possibilities and create a more extensive scenario library; to obtain the value of the activation probability for each target scenario of the target user through calculation, and to generate a scenario recommendation list by ranking the target scenarios based on the values of their activation probabilities, so as to provide personalized recommendations for the target user based on the order of recommendations from the scenario recommendation list, enabling users to quickly find scenarios that meet their needs, ultimately enhancing user experience.

In the embodiments provided in the present application, it should be understood that the disclosed method and device may be realized in other ways. The device embodiment described above is merely illustrative. For example, the division of units is only one logical functional division, and there can be other ways of division in actual realization. For instance, a plurality of units or components may be combined or integrated into another system, or some features may be omitted or not executed. Furthermore, the coupling between elements displayed or discussed may also be direct coupling or communication or indirect coupling or communication through communication interfaces, devices, or units, and such coupling may take various forms including electrical, mechanical, or other forms.

The units described as separate components may or may not be physically separated and the components shown as units may or may not be physical units, i.e., they may be located in one place or distributed across a plurality of network units. Some or all of these units may be selected as needed to realize the objectives of the solution of this embodiment.

Furthermore, in the embodiments provided in the present application, various functional units may be integrated into one processing unit, or they may exist separately as individual units, or two or more units may be integrated into one unit.

The described functionalities, when realized as software functional units and sold or used as standalone products, may be stored on a computer-readable storage medium. Based on this understanding, the essential part of the technical solutions in the present application, or in other words, the contributory part to prior art, may be embodied in the form of software products. This computer software product is stored on a storage medium and comprises several instructions to enable a computing device (such as a personal computer, server, or network device, etc.) to execute all or part of the steps of the method described in various embodiments of the present application. The aforementioned storage medium may be any of various types of media capable of storing program code, such as USB drives, mobile hard disk, read-only memory (ROM), random access memory (RAM), magnetic disks, or optical disks.

It should be noted that similar reference numerals and letters in the following drawings represent similar items. Therefore, once an item is defined in one drawing, it does not need to be further defined or explained in subsequent drawings. In addition, the terms “first,” “second,” “third,” etc., are used solely for descriptive purposes and should not be understood as indicating or implying relative importance.

It should be noted that in the embodiments described in the present application, the term “comprising” is used to indicate the presence of the features stated thereafter but does not exclude the addition of other features.

Unless otherwise defined, all technical and scientific terms used herein have the same meanings as commonly understood by those skilled in the art to which the present application belongs. The terminology used in this document is for the purpose of describing the embodiments of the present application and is not intended to limit the scope of the present application.

Finally, it should be noted that the embodiments described above are only specific embodiments of the present application for the purpose of illustrating the technical solutions of the present application, and are not intended to limit the scope of the present application. The scope of protection of the present application is also not limited to these embodiments. Although detailed descriptions have been provided with reference to the above embodiments in the present application, those of ordinary skill in the art should understand that any person skilled in the art may still make modifications or easily conceive variations to the technical solutions described in the above embodiments, or make equivalent substitutions for some of the technical features therein within the technical scope disclosed in the present application. Furthermore, these modifications, variations, or equivalent substitutions do not alter the essence of the corresponding technical solutions and should fall within the spirit and scope of the technical solutions provided in the embodiments of the present application. They should also be encompassed within the scope of protection of the present application. Therefore, the scope of protection of the present application should be determined by the scope of protection of the claims.

1. A method for recommending smart home scenarios comprising:
Selecting trigger conditions and execution actions that meet predefined selection criteria from user-activated scenarios from a user group within a predefined time period; wherein, each user-activated scenario comprises at least one trigger condition and at least one execution action;
Combining the selected trigger condition and the selected execution action to generate at least one target scenario;
Calculating a value of the activation probability for each target scenario of a target user; and
Generating a scenario recommendation list by ranking each target scenario in an arrangement order based on the values of each target scenario's activation probability.

2. The method for recommending smart home scenarios according to claim 1, wherein selecting trigger conditions and execution actions further comprises:
separately counting the activation frequency of each trigger condition and each execution action based on the trigger conditions and execution actions in the user-activated scenarios;
sorting the trigger conditions in the user-activated scenarios in descending order of activation frequency and selecting a plurality of trigger conditions; and
sorting the execution actions in the activated user-activated scenarios in descending order of activation frequency and selecting a plurality of execution actions.

3. The method for recommending smart home scenarios according to claim 1, wherein the method further comprises obtaining updated user-activated scenarios by periodically acquiring user-activated scenario from a user group.

4. The method for recommending smart home scenarios according to claim 1, wherein generating at least one target scenario further comprises combining each of the selected trigger conditions with the selected execution actions, respectively, thereby obtaining a combination of at least one trigger condition and at least one execution action;
and generating at least one target scenario based on the combination of at least one trigger condition and at least one execution action.

5. The method for recommending smart home scenarios according to claim 1, wherein calculating a value of the activation probability further comprises calculating an activation count of each of the target scenarios, at least one rate of compliance with the target user's needs, a measure of device relevance, a measure behavioral relevance, a measure of attribute relevance, and the target scenario duplication for each target scenario; and
calculating the value of the activation probability for each target scenario of the target user by calculating the activation count of each of the target scenarios, the rates of compliance with the target user's needs, device relevance, behavioral relevance, attribute relevance, and scenario duplication for each scenario.

6. The method for recommending smart home scenarios according to claim 1, wherein generating a scenario recommendation list further comprises obtaining a sorted result of a plurality of activation probability values by sorting the values representing the activation probabilities for the respective target scenarios in descending order;
determining a ranking of the target scenarios based on the sorted result of a plurality of activation probability values;
and generating a scenario recommendation list based on the ranking of the target scenarios.

7. The method for generating and recommending smart home scenarios according to claim 1, wherein the method further comprises selecting a predefined number of scenarios from top-ranking scenarios from the scenario recommendation list as the recommended scenarios for recommendation to the user;
removing recommended scenarios that have not been activated and have reached a predefined threshold count for non-activation, and updating the arrangement order of scenarios within the scenario recommendation list.

8. An device for recommending home scenarios comprising:
at least one processor and a non-transitory storage medium storing program instructions, wherein the at least one processor, by executing the program instructions, causes the device to execute the following operations:
selecting at least one trigger condition and at least one execution action that meet predefined selection criteria from at least one user-activated scenario of a user group within a predefined time period; wherein, said at least one user-activated scenario comprises at least one trigger condition and at least one execution action;
combining the selected trigger condition and the selected execution action to generate at least one target scenario;
calculating and obtaining the value of the activation probability for said at least one target scenario of a target user; and
generating a scenario recommendation list by ranking at least one target scenario based on the values of said at least one target scenario's activation probability in an arrangement order.

9. The device for recommending home scenarios according to claim 8, wherein the at least one processor, by executing the program instructions, further causes the device to:
count the activation frequency of each trigger condition and each execution action based on the trigger conditions and execution actions in the user-activated scenarios;
sort the trigger conditions in the user-activated scenarios in descending order of activation frequency and selecting a plurality of trigger conditions; and
sort the execution actions in the historically activated user-activated scenarios in descending order of activation frequency and selecting a plurality of execution actions.

10. The device for recommending home scenarios according to claim 8, wherein the at least one processor, by executing the program instructions, further causes the device to:
obtain updated user-activated scenarios by periodically acquiring user-activated scenario from a user group.
wherein selecting at least one trigger condition and at least one execution action further comprises selecting at least one trigger conditions and at least one execution actions that meet predefined selection criteria from the updated user-activated scenarios.

11. The device for recommending home scenarios according to claim 8, wherein the at least one processor, by executing the program instructions, further causes the device to:
combine each of the selected trigger conditions with the selected execution actions, respectively, thereby obtaining a combination of at least one trigger condition and at least one execution action; and
generate at least one target scenario based on the combination of at least one trigger condition and at least one execution action.

12. The device for recommending home scenarios according to claim 8, wherein the at least one processor, by executing the program instructions, further causes the device to:
calculate an activation count of each of the target scenarios, at least one rate of compliance with the target user's needs, a measure of device relevance, a measure behavioral relevance, a measure of attribute relevance, and the target scenario duplication for each target scenario; and
calculate the value of the activation probability for each target scenario of the target user by calculating the activation count of each of the target scenarios, the rates of compliance with the target user's needs, device relevance, behavioral relevance, attribute relevance, and scenario duplication for each scenario.

13. The device for recommending home scenarios according to claim 8, wherein the at least one processor, by executing the program instructions, further causes the device to:
obtain a sorted result of a plurality of activation probability values by sorting the values representing the activation probabilities for the respective target scenarios in descending order;
determine a ranking of the target scenarios based on the sorted result of a plurality of activation probability values; and
generate a scenario recommendation list based on the ranking of the target scenarios.

14. The device for recommending home scenarios according to claim 8, wherein the at least one processor, by executing the program instructions, further causes the device to:
select a predefined number of scenarios from top-ranking scenarios from the scenario recommendation list as the recommended scenarios for recommendation to the user;
remove recommended scenarios that have not been activated and have reached a predefined threshold count for non-activation; and
update the arrangement order of scenarios within the scenario recommendation list.

15. A non-transitory computer-readable storage medium, storing at least one instruction, wherein the at least one instruction is loaded and executed by a processor to implement:
selecting at least one trigger condition and at least one execution action that meet predefined selection criteria from at least one user-activated scenario of a user group within a predefined time period; wherein, said at least one user-activated scenario comprises at least one trigger condition and at least one execution action;
combining the selected trigger condition and the selected execution action to generate at least one target scenario;
calculating and obtaining the value of the activation probability for said at least one target scenario of a target user; and
generating a scenario recommendation list by ranking at least one target scenario based on the values of said at least one target scenario's activation probability in an arrangement order.

16. The non-transitory computer-readable storage medium according to claim 15, wherein the at least one instruction is loaded and executed by the processor to further implement:
separately counting the activation frequency of each trigger condition and each execution action based on the trigger conditions and execution actions in the user-activated scenarios;
sorting the trigger conditions in the user-activated scenarios in descending order of activation frequency and selecting a plurality of trigger conditions; and
sorting the execution actions in the activated user-activated scenarios in descending order of activation frequency and selecting a plurality of execution actions.

17. The non-transitory computer-readable storage medium according to claim 15, wherein the at least one instruction is loaded and executed by the processor to further implement:
obtaining updated user-activated scenarios by periodically acquiring user-activated scenario from a user group.

18. The non-transitory computer-readable storage medium according to claim 15, wherein the at least one instruction is loaded and executed by the processor to further implement:
combining each of the selected trigger conditions with the selected execution actions, respectively, thereby obtaining a combination of at least one trigger condition and at least one execution action;
and generating at least one target scenario based on the combination of at least one trigger condition and at least one execution action.

19. The non-transitory computer-readable storage medium according to claim 15, wherein the at least one instruction is loaded and executed by the processor to further implement:
calculating an activation count of each of the target scenarios, at least one rate of compliance with the target user's needs, a measure of device relevance, a measure behavioral relevance, a measure of attribute relevance, and the target scenario duplication for each target scenario; and
calculating the value of the activation probability for each target scenario of the target user by calculating the activation count of each of the target scenarios, the rates of compliance with the target user's needs, device relevance, behavioral relevance, attribute relevance, and scenario duplication for each scenario.

20. The non-transitory computer-readable storage medium according to claim 15, wherein the at least one instruction is loaded and executed by the processor to further implement:
obtaining a sorted result of a plurality of activation probability values by sorting the values representing the activation probabilities for the respective target scenarios in descending order;
determining a ranking of the target scenarios based on the sorted result of a plurality of activation probability values;
and generating a scenario recommendation list based on the ranking of the target scenarios.
